(19) United States
(12) Patent Application Publication
(10) Pub. No.: US 2024/0331088 A1
(43) Pub. Date: Oct. 3, 2024

(54) LIGHTWEIGHT RENDERING SYSTEM WITH ON-DEVICE RESOLUTION IMPROVEMENT

(71) Applicant: SAMSUNG ELECTRONICS CO., LTD., Gyeonggi-Do (KR)

(72) Inventors: Rahul Lokesh, Sunnyvale, CA (US); Sandipan Banerjee, Boston, MA (US); Hyun Jae Kang, Mountain View, CA (US); Ondrej Texler, San Jose, CA (US); Sajid Sadi, San Jose, CA (US)

(21) Appl. No.: 18/422,466

(22) Filed: Jan. 25, 2024

Related U.S. Application Data
(60) Provisional application No. 63/456,337, filed on Mar. 31, 2023.

(51) Int. Cl. G06T 3/4053; G06T 3/4046

(52) U.S. Cl. CPC G06T 3/4053; G06T 3/4046

(57) ABSTRACT

An ultralight rendering system is capable of generating first content locally within a first data processing system. The first data processing system is capable of monitoring for second content conveyed from a second data processing system. The first data processing system plays a version of the first content. The first data processing system is capable of dynamically switching, by the first data processing system, between playing the version of the first content and playing a version of the second content based on receipt of the second content by the first data processing system.

### CROSS-REFERENCE TO RELATED APPLICATIONS

This application claims the benefit of U.S. Application No. 63/456,337 filed on Mar. 31, 2023, which is fully incorporated herein by reference.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to an interactive system and, more particularly, to a lightweight content rendering system with on-device resolution improvement.

### BACKGROUND

The use of life-like avatars referred to as digital humans or virtual humans is becoming increasingly popular. Digital humans may be used in a variety of different contexts including, but not limited to, the metaverse, gaming, and as part of any of a variety of virtual experiences in which human beings increasingly wish to take part. Advances in computer technology and neural networks have enabled the rapid virtualization of many different “real world” activities.

The creation of digital humans has been, and remains, a complex task that requires cooperative operation of one or more neural networks and deep learning technologies. The digital human must be capable of interacting with a human being, e.g., by engaging in interactive dialog, in a believable manner. This entails overcoming challenges relating to the generation of a highly detailed visual rendering of the digital human, the generation of believable and natural animations synchronized with audio, and doing so such that interactions are perceived by human beings to occur in real-time operation and/or without undue delay.

The video inferencing processes that generate the video streams of digital humans are computationally expensive. That is, the processes require significant compute resources and runtime. In many cases, the inferencing processes require that the computer systems have strong Graphics Processing Units (GPUs). GPUs having the compute power necessary for the generation of digital humans are expensive and add complexity to the server systems used to perform the inferencing processes. These factors, among others, make it costly and technologically difficult to scale up computer systems that provide interactive digital human experiences capable of serving thousands or possibly millions of end-users.

### SUMMARY

In one or more embodiments, a computer-based method includes generating first content locally within a first data processing system. The method includes monitoring, by the first data processing system, for second content conveyed from a second data processing system. The method includes playing a version of the first content by the first data processing system. The method includes dynamically switching, by the first data processing system, between playing the version of the first content and playing a version of the second content based on receipt of the second content by the first data processing system.

In one or more embodiments a system, apparatus, or device includes a processor configured to execute the various operations described within this disclosure.

In one or more embodiments, a computer program product includes a computer readable storage medium having program code stored thereon. The program code is executable by a processor and/or data processing system to perform the various operations described within this disclosure.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an interactive system in accordance with one or more embodiments of the disclosed technology.

FIG. 2 illustrates a data flow between the various components of the interactive system of FIG. 1 in accordance with one or more embodiments of the disclosed technology.

FIG. 3 illustrates certain operative features of a server-side interactive framework and a lightweight network of the interactive system in accordance with one or more embodiments of the disclosed technology.

FIGS. 4A and 4B, taken collectively, illustrate differences in image quality that may be obtained by using a naïve interpolation technique compared to a super-resolution network in accordance with one or more embodiments of the disclosed technology compared.

FIG. 5 illustrates certain operative features of the interactive system in which latent space image representations are used in accordance with one or more embodiments of the disclosed technology.

FIG. 6 illustrates the interactive system used in the context of chat support in accordance with one or more embodiments of the disclosed technology.

FIG. 7 illustrates an example in which a device implementing certain features of the interactive system is implemented as a kiosk in accordance with one or more embodiments of the disclosed technology.

FIG. 8 is a method illustrating certain operative features of the interactive system in accordance with one or more embodiments of the disclosed technology.

FIG. 9 illustrates an example of a data processing system for use with the interactive system in accordance with one or more embodiments of the disclosed technology.

FIG. 10 illustrates an example of a device for use with the interactive system in accordance with one or more embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to an interactive system and, more particularly, to a lightweight content rendering system with on-device resolution improvement. In accordance with the inventive arrangements disclosed herein, methods, systems, and computer program products are disclosed that are capable of delivering high quality video streams to users. The inventive arrangements include a remote system such as a server system operating in cooperation with a device. The remote system is capable of dynamically generating content that may be conveyed to the device. The remote system is also capable of caching pre-generated content that may be conveyed to the device.

In one or more embodiments, first content may be generated locally within a first data processing system. The first data processing system is capable of monitoring for second content conveyed from a second data processing system. The first data processing system may be a device such as a client device. The second data processing system may be a remote system such as one or more interconnected servers. The first data processing system is capable of playing a version of the first content. Further, the first data processing system is capable of dynamically switching between playing the version of the first content and playing a version of the second content based on receipt of the second content by the first data processing system.

The second data processing system may generate the content conveyed to the first data processing system. The second data processing system may store cached, e.g., pre-generated, content that may be conveyed to the first data processing system. The second data processing system also may convey a combination of dynamically generated and cached content to the first data processing system. The content may be video streams. A technical effect of using the second content received from the second data processing system interspersed with the first content generated locally within the first data processing system is reduced latency of the overall system that facilitates real-time operation or the perception of real-time and/or on-demand operation of the system to an end user.

In some aspects, the first content includes a first level of motion and the second content includes a second level of motion that exceeds the first level of motion. For example, the first content generated by the first data processing system may be content with a level of motion that does not exceed a threshold. Generating video streams that include reduced levels of motion is computationally less burdensome than generating video streams with higher levels of motion. As such, the computationally less taxing content may be generated locally within the first data processing system, e.g., the client device, while more computationally taxing content may be generated by the second data processing system, e.g., the server or server-based system. This reduces the amount of compute resources needed in the first data processing system and facilitates real-time operation and seamless playing of content in implementing an interactive dialog with a user of that system. As an illustrative and non-limiting example, the first content includes media (e.g., video) of a non-speaking digital human and the second content includes media (e.g., video) of the digital human speaking.

In some aspects, the first data processing system is capable of playing the version of the first content continuously in absence of the second content and until the second content is received. For example, in response to receiving the second content, the first data processing system may discontinue playing the version of the first content and play a version of the second content that was received from the second data processing system. The ability to switch between playing locally generated content and content obtained from another system further enhances the interactive nature of the overall system by reducing the overall system latency.

In one or more embodiments, inventive arrangements utilize a lightweight network to generate content. The content may be upsized or improved in terms of resolution prior to playing to a user using a lightweight super-resolution network. For example, in some aspects, the first content and the second content are generated at a first resolution. In that case, the version of the first content is generated by increasing the first resolution of the first content to a second resolution. The second resolution is higher than the first resolution. The version of the second content is generated by increasing the first resolution of the second content to the second resolution. Resolution may be increased within the first data processing system. Further, the increasing resolution may be performed as part of a rendering and/or playback operation performed by the first data processing system. A technical effect of using different resolutions and the upscaling of resolutions performed in the first data processing system is that any cached content stored on the second data processing system may be stored in the lower resolution thereby requiring less storage space. Further, conveying such content to the first data processing system requires less bandwidth. Any content, whether generated or cached, within the first data processing system also requires less storage space.

In some aspects, an identity-specific, generative machine learning model is used to increase the first resolution of the first content and to increase the first resolution of the second content. The identity-specific, generative machine learning model is a model that has been trained to increase or improve the resolution of an image of a particular digital human. The particular digital human is one having a particular identity and is recognizable by human beings as “the same person or avatar.” The identity-specific, generative machine learning model executes in the first data processing system to operate on content generated locally within the first data processing system and on content received from the second data processing system. A technical effect of using an identity-specific, generative machine learning model is the reduction of noticeable artifacts within the upscaled images that are output from the interactive system. Further, certain features that are considered important to the identity of the digital human are better preserved than were a naïve approach for increasing resolution to be used that is unaware of the identity of the digital human specified by the frames of video.

The increase in resolution may be performed in a variety of different ways. In some aspects, the first content includes one or more first red, green, blue (RGB) images and the second content includes one or more second RGB images. In this example, the identity-specific, generative machine learning model operates on the RGB images.

In some aspects, the first content includes one or more first latent space image representations and the second content includes one or more second latent space image representations. In this example, the identity-specific, generative machine learning model operates on the latent space image representations.

For example, for the one or more first latent space image representations, the version of the first content is generated as one or more RGB images of a digital human that correspond to the one or more first latent space image representations. For the one or more second latent space image representations, the version of the second content is generated as one or more RGB images of the digital human that correspond to the one or more second latent space image representations. A technical effect of operating on the latent space image representations is that the latent space image representations require less storage space than RGB images and may be conveyed using less bandwidth. Further, the resulting RGB images generated from the latent space image representations may be of higher quality than were RGB images upscaled or increased in resolution.

Within this disclosure, various items such as, for example, the first content, the second content, the first latent space image representation, and/or the second latent space image representation are generally described as each including one or more of such items. In one or more embodiments, the inventive arrangements are operative on one item/image at a time. For example, the various systems and/or subsystems described herein, whether operating on a server or on a device such as a client device, may produce one item (e.g., RGB image or latent space image representation) at a time that is passed on to another system and/or subsystem for upscaling such that the upscaling is performed on a one-to-one basis in response to each item received for processing. Thus, the system and/or subsystem that performs upscaling may generate one output item in response to each input item received for processing.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

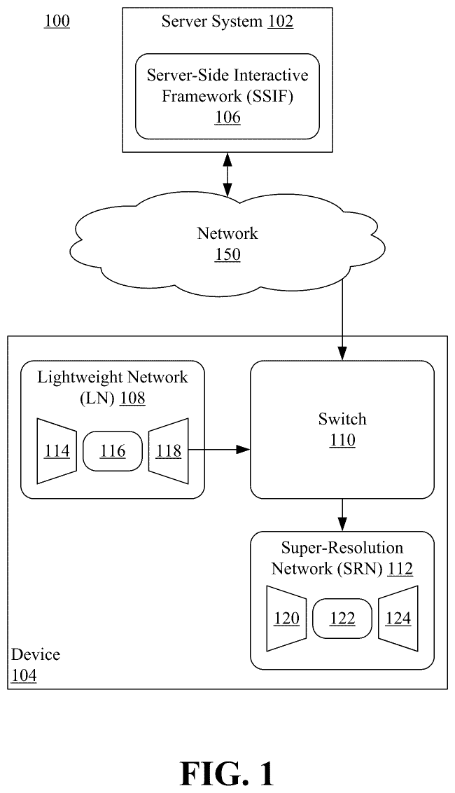

FIG. 1 illustrates an interactive system 100 in accordance with one or more embodiments of the disclosed technology. In the example of FIG. 1, interactive system 100 includes a server system 102 in communication with one or more devices 104. While one device 104 is shown for case of illustration, it should be appreciated that server system 102 may be in communication with a plurality of, e.g., many, such devices. In one or more embodiments, interactive system 100 is configured as a fully interactive, cached, and scalable system for two-way interaction with one or more users. In one or more of the examples described herein, interactive system 100 is capable of interacting with users by way of content that is, or includes, a form of synthetic media such as digital humans.

In one or more embodiments, a digital human is a computer-generated entity that is rendered visually with a human-like appearance. The digital human may be an avatar. In some embodiments, a digital human is a photorealistic avatar. In some embodiments, a digital human is a digital rendering of a hominid, a humanoid, a human, or other human-like character. A digital human may be an artificial human. A digital human can include elements of artificial intelligence (AI) for interpreting user input and responding to the input in a contextually appropriate manner. The digital human can interact with a user using verbal and/or non-verbal cues. Implementing natural language processing (NLP), a chatbot, and/or other software, the digital human can be configured to provide human-like interactions with a human being and/or perform activities such as scheduling, initiating, terminating, and/or monitoring of the operations of various systems and devices.

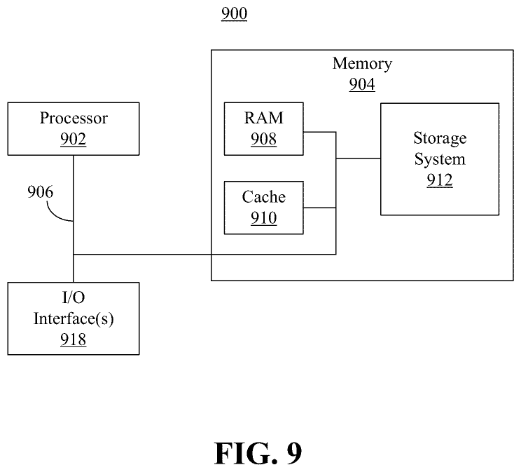

In the example of FIG. 1, interactive system 100 includes a framework that is executable by the various computing systems and/or devices illustrated. For example, the framework may be executed by one or more interconnected data processing systems (e.g., computers). Server system 102 may be implemented as one or more interconnected servers executing suitable software. As defined herein, the term “server” means a data processing system configured to share services with one or more other data processing systems. An example of a data processing system that is suitable for use in interactive system 100 is described in connection with FIG. 9.

Interactive system 100 is coupled to a network 150. Network 150 may be implemented as or include any combination of the Internet, a mobile network, a Local Area Network (LAN), a Wide Area Network (WAN), a personal area network (PAN), one or more wired networks, one or more wireless networks, or the like. Network 150 may include copper transmission cables, optical transmission fibers, wireless transmission, routers, firewalls, switches, gateway computers and/or edge devices including edge servers. The various devices and/or systems illustrated in FIG. 1 may include respective network adapters or network interfaces in order to communicate over network 150.

In the example, server system 102 executes a server-side interactive framework (SSIF) 106. SSIF 106 may include a variety of different software components such as a chat bot, content generation models (e.g., audio content generation models and/or video content generation models), and cached content in the form of pre-generated content. The content generation models may be implemented as any of a variety of machine learning models such as neural networks including deep neural networks. From time-to-time within this disclosure, reference is made to a full-scale rendering network. The full-scale rendering network is an example of model that is included within SSIF 106.

In one or more example implementations, the content generation models, whether included in server system 102 or device 104, may be implemented as generative models. An example of a generative model is an image-to-image translation network. Accordingly, the content generation models included device 104 and/or SSIF 106 may include one or more Generative Adversarial Networks (GANs) and/or one or more Variational Autoencoders (VAEs).

In general, a GAN includes two neural networks referred to as a generator and a discriminator. The generator and the discriminator are engaged in a zero-sum game with one another. Given a training set, a GAN is capable of learning to generate new data with the same statistics as the training set. As an illustrative example, a GAN that is trained on an image or image library is capable of generating different images that appear authentic to a human observer. In a GAN, the generator generates images. The discriminator determines a measure of realism of the images generated by the generator. As both neural networks may be dynamically updated during operation (e.g., continually trained during operation), the GAN is capable of learning in an unsupervised manner where the generator seeks to generate images with increasing measures of realism as determined by the discriminator.

An autoencoder refers to an unsupervised artificial neural network that learns how to efficiently compress and encode data. The autoencoder learns how to reconstruct the data back from the reduced encoded representation to a representation that is as close to the original input as possible. A VAE is an autoencoder whose encodings distribution is regularized during the training in order to ensure that the latent space has properties sufficient to allow the generation of some portion of new data.

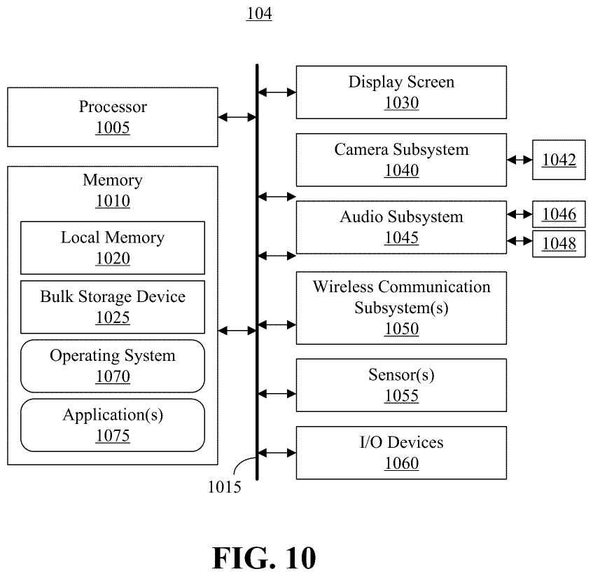

Device 104 is coupled to network 150 and is capable of communicating with server system 102 via network 150. Example implementations of different types of device 104 are described in connection with FIGS. 9 and 10. Examples of device 104 include, but are not limited to, any of a variety of user devices. Examples of user devices may include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television, information appliance, IoT device, or the like. In another example, device 104 may be a kiosk, a kiosk configured with a video display and/or audio capabilities, or other computing or information appliance that may be positioned so as to be accessible by a plurality of different users over time.

In one or more embodiments, device 104 is implemented as a client device. As defined herein, the term “client device” means a data processing system that requests shared services from a server, and with which a user directly interacts. Network infrastructure, such as routers, firewalls, switches, access points and the like, are not client devices as the term “client device” is defined herein.

In the example of FIG. 1, device 104 includes a lightweight network (LN) 108, a switch 110, and a super-resolution network (SRN) 112. Device 104 is also referred to herein as the “first data processing system.” In one or more embodiments, LN 108 is implemented as an autoencoder. For example, LN 108 may be implemented as a VAR. In the example, LN 108 includes an encoder 114 configured to translate input instances into latent space image representations 116. The latent space image representations 116 are encoded in a latent space. LN 108 also includes a decoder 118 configured to translate the latent space image representation 116 into decoded versions of the latent space image representations 116. In one or more examples, the output generated by decoder 118 is one or more red, green, blue (RGB) images generated from the latent space image representations 116. Output generated by decoder 118 is conveyed to switch 110.

In one or more other embodiments, LN 108 may be implemented to include encoder 114 and omit decoder 118. In that case, encoded content generated by encoder 114 may be provided directly to switch 110. The encoded content, e.g., one or more latent space image representations 116 generated by encoder 114, is provided to switch 110. For example, the latent space image representations 116.

In one or more embodiments, SRN 112 is implemented as a VAR. In the example, SRN 112 includes an encoder 120 configured to translate content received from switch 110 into latent space representations 122 of the content received from switch 110. The latent space representations 122 are encoded in a latent space. In some examples, the latent space used by SRN 112 may be the same as the latent space used by LN 108. SRN 112 further includes a decoder 124 configured to translate the latent space image representations 122 into decoded versions of the latent space image representations 122. In one or more examples, the output generated by decoder 124 is one or more RGB images. Output generated by decoder 124 may be provided to a display screen, an output transducer, or the like of device 104 for consumption by a user of device 104.

In the one or more other embodiments where LN 108 conveys latent space image representations 116 to switch 110, SRN 112 may be implemented to include decoder 124 and omit encoder 120. In that case, the latent space representations 122 may be the same as or include the latent space image representations 116 output from LN 108 through switch 110.

In the example of FIG. 1, switch 110 is configured to dynamically switch between passing content received from LN 108 and content received from server system 102 to SRN 112. Server system 102 is also referred to herein as the “second data processing system.” In one or more embodiments, switch 110 determines which content to pass and when. In this regard, it should be appreciated that the content output from server system 102 may be similar to the content output from LN 108. More particularly, in the examples where LN 108 outputs one or more RGB images as the content, server system 102, in executing SSIF 106 therein, also outputs content that includes RGB images. In the examples where LN 108 outputs latent space image representations 116 to switch 110, server system 102 outputs latent space representations as the content. Content from server system 102, whether RGB images or latent space image representations either of which may be provided as a video stream, also may include or be accompanied by audio that is to be played in a synchronized manner with the visual content provided from server system 102.

In the example of FIG. 1, each of LN 108 and SSIF 106 is configured to generate content in a first resolution. SRN 112 is configured to receive such content and adjust the resolution to a second resolution. The second resolution is higher than the first resolution. In one or more examples, SRN 112 is configured to up-sample or up-scale content received from switch 110, whether the content is from LN 108 or SSIF 106. The up-sampling performed by SRN 112 on device 104 means that smaller files may be stored on server system 102. Further, the computing resources needed to generate the content, whether by SSIF 106 or LN 108, are reduced since the data being generated is of a lower resolution. Sending lower resolution data from server system 102 to device 104 uses less bandwidth and may also improve the overall latency of interactive system 100.

For purposes of illustration, consider an example in which a user accesses device 104, which may be a mobile phone, an appliance, a kiosk, or the like. Device 104 has software executing therein (e.g., LN 108, switch 110, and SRN 112). Device 104 may establish a communication session with server system 102 over network 150. In the example, device 104 may begin playing content generated by LN 108. That is, LN 108 generates content. Switch 110 passes the content to SRN 112. SRN 112 generates RGB images that are displayed by device 104 (e.g., on a display screen thereof). In one or more example implementations, the content generated by LN 108 specifies a digital human. The digital human may be in a listening or wait state. In this regard, LN 108 is generating content with a low degree of motion. For example, the content generated by LN 108 specifies a digital human that is awaiting input from a user. The digital human, as specified by the content generated by LN 108 is not speaking (e.g., is non-speaking). This means there is little to no mouth movement for the digital human. Content output from LN 108 that passes through switch 110 is up-sampled from the first resolution to the second resolution prior to being displayed on the display screen of device 104.

The user interacts with device 104 by providing a query or asking questions and receives responses from the SSIF 106. Responses from SSIF 106 may be a continuous stream of content of a finite length whether dynamically generated (e.g., “on-the-fly” or in real-time), pre-generated, or a combination of both. The stream of content may be a video stream, an audio stream, and/or audio-visual stream. As an example, the stream of content may include the digital human speaking the response.

In response to the user providing input such as asking a question or providing a query, SSIF 106 may convey a response to device 104 and, more particularly, to switch 110. In response to detecting content received from SSIF 106, switch 110 stops passing content from LN 108 to SRN 112 and begins conveying content received from SSIF 106 to SRN 112. SRN 112 up-samples the received content from SSIF 106 from the first resolution to the second resolution prior to the content being displayed on the display screen of device 104.

In one or more embodiments, switch 110 is implemented as a network. The content generated by LN 108 may include the digital human in a non-speaking state with minimalistic motions. For example, the digital human may blink and/or look to the left or to the right. The digital human does not talk in this state. In one or more embodiments, a trigger that causes switch 110 to being transitioning to passing content from server system 102 or to start passing content from server system 102 is the user asking a question or providing a query. In the example, SSIF 106 may understand how to answer the question and provide a response. In response to switch 110 receiving the response, which includes audio information, switch 110 passes the content from server system 102 so that the digital human, as displayed on device 104 begins talking.

While content generated by LN 108 includes motion that is less than a specified threshold of motion, content generated by SSIF 106 includes, or typically includes, an amount of movement that is greater than or equal to the specified threshold of motion. As an illustrative and non-limiting example, whereas content generated by LN 108 specifies a non-speaking digital human, content generated by SSIF 106, being a response to a user input, specifies a speaking digital human. Thus, the content from SSIF 106 includes a greater amount of movement in that the mouth of the digital human is moving typically in a manner that is synchronized with and matching any speech/audio provided with the visual content. Content provided by SSIF 106 may be pre-generated (e.g., cached) content or dynamically generated content.

In the example of FIG. 1, LN 108 is capable of rendering non-talking sequences quickly and efficiently. Content generated by LN 108 may be used to “connect” or “bridge” two different talking sequences or responses from server system 102. The talking sequences may be cached content or dynamically generated content. While the example of FIG. 1 contemplates that responses, whether cached or dynamically generated, are provided by server system 102, in one or more other embodiments, such responses, whether cached or dynamically generated, may be created or cached by other models and/or systems (e.g., a database) on device 104.

In the example of FIG. 1, having some of the content being generated on device 104 (e.g., the non-talking sequences) helps to save bandwidth in that such content need not be conveyed to device 104 from another system over network 150. The use of SRN 112 allows device 104 to deliver higher resolution and sharper video streams. Because SRN 112 executes on device 104, any content streamed to device 104 can be of lower resolution. This means that not only is less bandwidth required to convey such content, but that less storage space is required and fewer computational resources are needed to generate such content.

Regardless of the source of any content, device 104 is capable of playing such content, e.g., audio, video, and/or video with synchronized audio via a display screen and/or through an output transducer (e.g., a speaker). Appreciably, device 104 may include an input transducer, e.g., a microphone, for receiving audio.

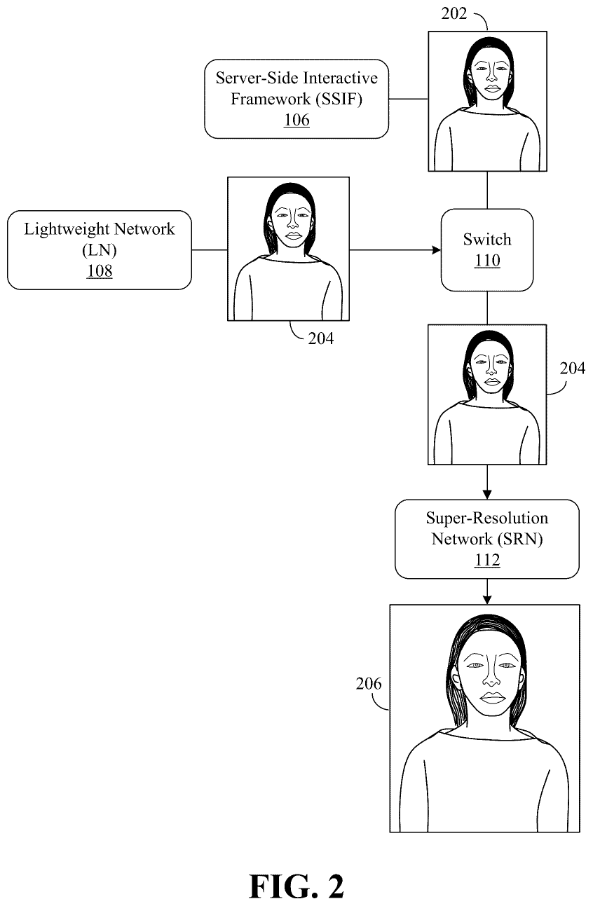

FIG. 2 illustrates a data flow between the various components of interactive system 100 of FIG. 1 in accordance with one or more embodiments of the disclosed technology. In the example of FIG. 2, SSIF 106 is implemented as, or includes, the full-scale rendering network. More particularly, SSIF 106 is capable of generating full scale images at the first resolution. It should be appreciated that SSIF 106 also may store pre-generated, or cached, full-scale images in the first resolution that may be recalled and played. In the example, SSIF 106 generates an RGB image 202 as the content. RGB image 202 is at the first, lower resolution. RGB image 202 specifies a rendering of a digital human with the mouth in a position that indicates lip motion. In some examples, the digital human of RGB image 202 may also include other body movements (e.g., more motion from one RGB image to the next).

LN 108 generates an RGB image 204 as content. RGB image 204 is also at the first, lower resolution. In the example, RGB image 204 specifies a rendering of a digital human (e.g., the same digital human or a digital human with the same identity as the digital human specified by content received from SSIF 106). In RGB image 204, the digital human is not speaking. That is, there is little to no lip motion from one RGB image to the next. Non-speaking images may be referred to herein as “neutral images.”

In one or more embodiments, LN 108 is implemented as a lower capacity version of the full-scale rendering network of SSIF 106. Despite the lower capacity, LN 108 is capable of generating realistic frames of content from an input instance while requiring fewer computational resources and less execution time than the full-scale rendering network of SSIF 106. For example, LN 108 may include a lighter weight encoder and a lighter weight decoder that have fewer trainable parameters compared to the encoder and decoder of the full-scale rendering network. This allows LN 108 to be trained faster and execute (e.g. perform inference) faster than the full-scale rendering network of SSIF 106. With LN 108, the content generated as output has an upper bound in terms of quality that does not exceed that of the full-scale rendering network of SSIF 106.

In general, use of LN 108 may entail a trade-off between the parameter reduction mentioned and possible loss of quality in the generated content given an input. In cases where the content generated by LN 108 includes little motion in the input instance that is encoded, LN 108 is capable of generating content that is interchangeable with the full-scale rendering network of SSIF 106.

In the example, for purposes of illustration, the first, lower resolution may be 256×256 pixels. In the example of FIG. 2, switch 110 passes content from LN 108, i.e., RGB image 204. Switch 110 passes RGB image 204, for example, in cases where no content is received from SSIF 106. In such cases, the interactive system is in a “wait” state. RGB image 204 is passed to SRN 112, which generates a higher resolution version of the received input (e.g., RGB image 204 in this case) as RGB image 206. For example, SRN 112 generates RGB image 206, which is a version of the received input albeit in a second, higher resolution. For purposes of illustration, the resolution of RGB image 206 may be 768×768 pixels. In generating RGB image 206, SRN 112 maintains fidelity to the received input and keeps the contents thereof intact. This means that the identity of the digital human specified in the received content, the facial expression, and pose are preserved from the received content to RGB image 206. It should be appreciated that the particular image dimensions given within this disclosure are provided for purposes of illustration and not limitation. Image dimensions (e.g., as given in pixels herein) other than those provided may be used so long as the relationship between the first resolution and the second resolution is maintained.

In one or more embodiments, switch 110 decides between passing content from LN 108 and SSIF 106 based on an amount of information encoded in the received content (e.g., the input signals received by switch 110). For generating non-talking images with little motion, LN 108 is called to output content that switch 110 passes to SRN 112. For talking images that may include some change in body pose and/or lip movement, SSIF 106 is called to output content that switch 110 passes to SRN 112. In one or more embodiments, switch 110 decides the mode of rendering that will be used (e.g., played to the user) for any particular image or sequence of images. For neutral sequences with little motion, LN 108 executing on device 104 is used for quick rendering. Otherwise, the full-scale rendering network of SSIF 106 or cached images from server system 102 is used.

Within this disclosure, motion may be measured by the change between two or more consecutive images in a sequence of images to be played. Motion may measure lip motion or other movements by other parts of the body of the digital human specified in the image sequence. Any of a variety of available motion measurement techniques as applied to images may be used. In another example, in cases where no audio is received from SSIF 106, switch 110 may pass content from LN 108 in lieu of any content received from SSIF 106. In response to detecting audio in content from SSIF 106, switch 110 may pass content from SSIF 106 in lieu of any content that may be received from LN 108.

For purposes of illustration, the example of FIG. 2 illustrates content being output from each of SSIF 106 and LN 108. While in some cases both SSIF 106 and LN 108 may output content in a manner that overlaps in time (e.g., simultaneously for at least short periods of time), in general operation of SSIF 106 and LN 108 may be coordinated by switch 110 and/or other functions of interactive system 100 to operate substantially serially. In coordinating operation, SSIF 106 and LN 108 may not generate content simultaneously. That is, LN 108 may not generate content for playback while content is received from SSIF 106. Otherwise, LN 108 may be configured to continually generate content at least until such time that content is detected as being received from SSIF 106.

In one or more embodiments, SRN 112 includes one or more up-sampling blocks that, combined with carefully designed objective functions, intelligently project each pixel of the lower resolution input to the high dimensional manifold of the output being generated. For example, SRN 112 may be identity-specific in that SRN 112 is trained to up-sample content specifying the same digital human so as to learn how to reliably preserver features such as identity, facial expressions, and pose. Compared to naïve interpolation techniques, SRN 112, being identity-specific, preserves high frequency or dense details (e.g., textures such as skin, wrinkles, hair, facial hair) and filters out artifacts in the high-resolution output. One benefit of SRN 112 being identity-specific is that the components thereof may be lightweight in nature (e.g., use fewer trainable parameters and/or use fewer layers) thereby requiring fewer computing resources (e.g., less processor power, reduced or no GPU usage, less memory) and/or using less runtime for performing inference.

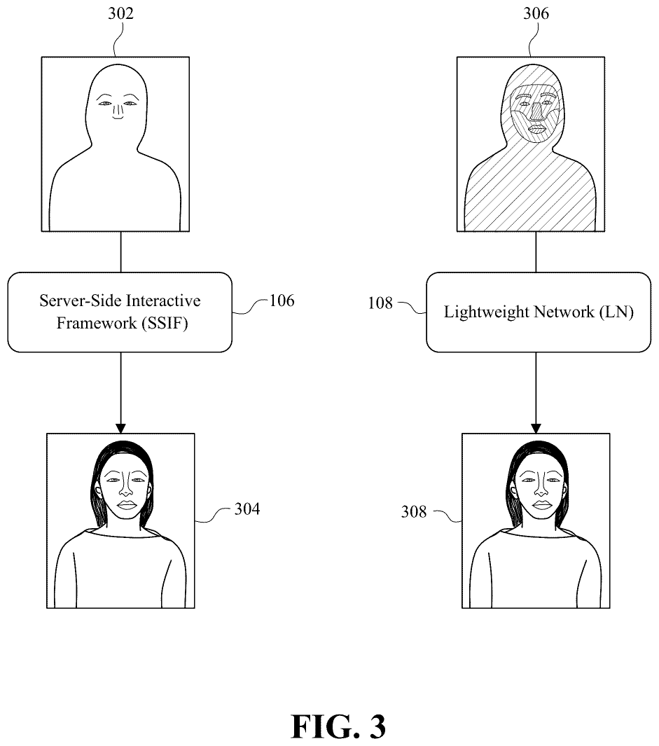

FIG. 3 illustrates certain operative features of SSIF 106 and LN 108 of interactive system 100 in accordance with one or more embodiments of the disclosed technology. The example of FIG. 3 illustrates several ways in which the full-scale rendering network of SSIF 106 may differ from LN 108.

In the example, the full-scale rendering network of SSIF 106 receives an input instance 302 in order to generate content. As illustrated, input instance 302 is an image frame that specifies one or more contour lines and one or more keypoints. The contour line(s) outline the shoulders, arms, and head of the digital human to be generated. The keypoints specify other features such as facial features including the eyes, eyebrows, and nose. In response to receiving input instance 302, the full-scale rendering network of SSIF 106 is capable of generating an RGB image 304. Both input instance 302 and RGB image 304 are specified in the first, lower resolution.

By comparison, LN 108 receives an input instance 306. Input instance 306 also may include one or more contour lines and one or more keypoints. Input instance 306, however, includes more information than input instance 302. As may be observed, input instance 306 includes more information. In other words, input instance 306 includes denser details compared to input instance 302. In the example, it may be observed that input instance 306 provides greater detail as to facial features than input instance 302. For example, input instance 306 specifies more information in the form of check contour, mouth and lip information, and eye and eyebrow information. In response to receiving input instance 306, LN 108 is capable of generating an RGB image 308. Both input instance 306 and RGB image 308 are specified in the first, lower resolution.

As discussed, the components of LN 108, e.g., encoder 114 and decoder 118, are lightweight in comparison to those of the full-scale rendering network of SSIF 106. The encoder 114 and decoder 118, for example, use fewer trainable parameters than the full-scale rendering network encoder and decoder counterparts. In one or more aspects, LN 108 uses fewer trainable parameters in that the mouth and lip positions are given by input instance 306. By comparison, mouth and lip positions for the full-scale rendering network of SSIF 106 may be determined from additional audio features extracted from the speech (e.g., audio) to be spoken by the digital human. As the audio features may be omitted from operation of LN 108, the number of trainable parameters is reduced.

In the example of FIG. 3, feeding in dense representations for a particular digital human (e.g., a particular identity) as shown in input instance 306, signals to LN 108 to pay more attention to those particular high frequency or dense aspects. The denser representation of input instance 306 also allows LN 108 to be further optimized (e.g., pruned) since the particular features that make the digital human recognizable as a particular digital human (a particular identity) are known and preserved while those features that do not contribute to recognizability of the digital human by human beings may be dropped.

In consequence, LN 108 executes faster and requires less memory than the full-scale rendering network of SSIF 106. In the example, both the full-scale rendering network and LN 108 generate similar outputs. In general, however, the output generated by LN 108 may be of lesser quality than the output generated by SSIF 106. The reduction in quality may occur in consequence of the lightweight operation and other performance gains provided by LN 108.

In the example of FIG. 3, the input instances provided to SSIF 106 and to LN 108 are stored in each respective system. That is, input instances 302 consumed by SSIF 106 for generating content are stored in server system 102. The input instances 306 consumed by LN 108 for generating content are stored in device 104. As the input instances 302 and 306 are stored in the first resolution, it may be observed that less storage capacity is required to store such data.

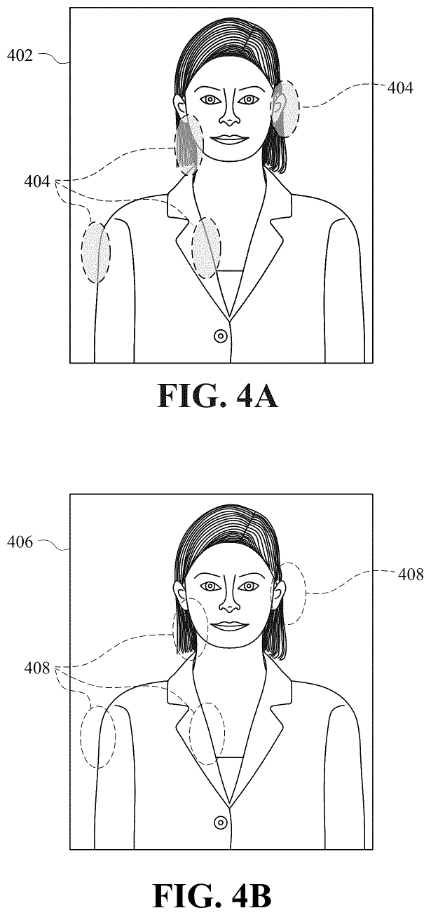

FIGS. 4A and 4B, taken collectively, illustrate differences in image quality that may be obtained by using a naïve interpolation technique compared to using SRN 112 in accordance with one or more embodiments of the disclosed technology compared. As discussed, SRN 112 is trained as an identity-specific machine learning model.

FIG. 4A illustrates an example where an input image having a first, lower resolution is interpolated to generate image 402. Image 402 has the second, higher resolution than the first, lower resolution image. The interpolation technique used in FIG. 4A to generate image 402 is a naïve technique that is unaware of the content specified by the image to be operated on. In the example of FIG. 4A, regions 404 illustrate jagged edges (e.g., aliasing) and pixelation.

FIG. 4B illustrates an example image 406 generated as output from SRN 112 given the same input image used for naïve interpolation in FIG. 4A. As may be observed, the regions 408, which correspond to respective ones of regions 404 from image 402, have greater clarity. That is, regions 408 have fewer artifacts (e.g., less blur, aliasing, and/or less pixelation). Because SRN 112 is implemented as a machine learning model trained using the particular identity of digital human illustrated, the up-sampling components of SRN 112 intelligently render each pixel to preserve the high frequency details of the input image. Additionally, the objective functions used for training SRN 112 ensure the necessary information of each facial part is kept aligned with the original (e.g., input image). In one or more embodiments, SRN 112 is capable of generating an image with a 3×-8× increase in resolution from the received input image while preserving content (i.e., identity, expression, pose) of the input image.

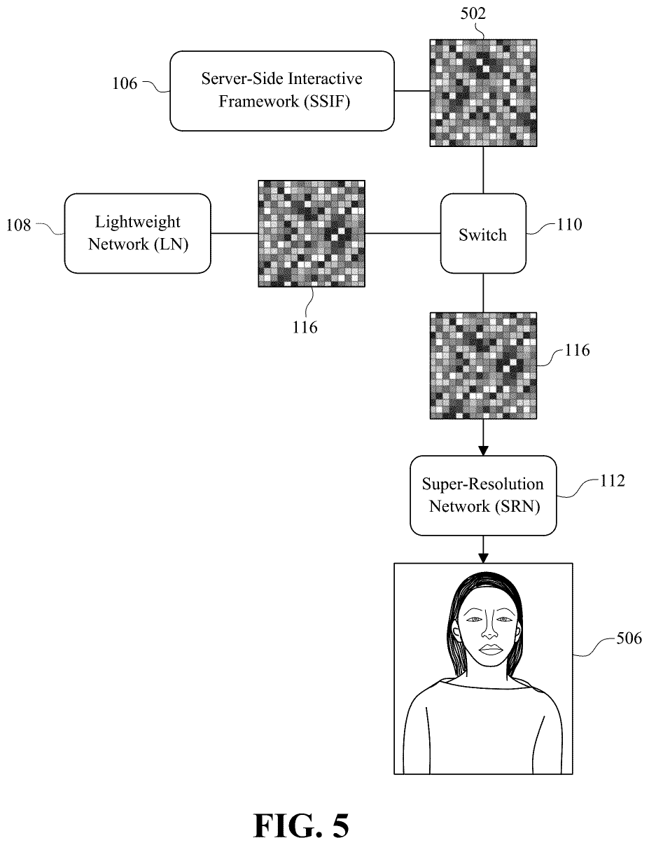

FIG. 5 illustrates certain operative features of interactive system 100 in which latent space image representations are used in accordance with one or more embodiments of the disclosed technology. In the example of FIG. 5, each of SSIF 106 and LN 108 is configured to output latent space image representations. In the example of FIG. 5, SSIF 106 may include an encoder of the full-scale rendering network included therein (omitting the decoder). LN 108 may include encoder 114 and omit decoder 118. FIG. 5 illustrates an embodiment in which latent space image representations 116 from LN 108 and latent space image representations 502 from SSIF 106 are provided to switch 110 in lieu of providing RGB images. In providing latent space image representations, SSIF 106 may dynamically generate such content as described or provide cached versions of the latent space image representations. Switch 110 passes either latent space image representations 116 from LN 108 or latent space image representations from SSIF 106 on to SRN 112. In choosing to pass content from LN 108 or SSIF 106, switch 110 may operate substantially as described herein as if RGB images were received.

In generating content such as RGB image 506, SRN 112 may be trained on latent space image representations as opposed to being trained on RGB images of the first resolution. Accordingly, SRN 112 is capable of receiving a latent space image representation and generating RGB image 506 therefrom. In one or more embodiments, SRN 112 may be implemented as one or more Latent Diffusion models. In the example, each of SSIF 106 and LN 108 is capable of outputting latent space image representations where each such representation may be 64×64 in terms of pixels with 16 channels (e.g., as opposed to 3 channels corresponding to RGB). Such an arrangement requires less bandwidth and storage space (e.g., 64×64×16) compared to embodiments that store RGB images of the first resolution (e.g., 256×256×3) as previously discussed herein. In some embodiments, providing latent space image representations to SRN 112 may lead to SRN 112 to produce output RGB images of higher quality than had lower resolution RGB images been provided to SRN 112 as input.

The inventive arrangements are capable of communicating naturally, responding in contextualized exchanges, and interacting with real humans in an efficient manner with reduced latency and reduced computational overhead. Accordingly, interactive system 100 may be incorporated into a variety of different systems and/or used in a variety of different contexts. As an illustrative and non-limiting example, interactive system 100 may be used with or as part of an online video gaming system or network. Further examples and use cases are described hereinbelow.

The inventive arrangements described herein may be used to generate digital humans within virtual computing environments, e.g., metaverse worlds. The digital humans may be generated in high resolution for use as avatars, for example. The high-quality and high resolution achieved is suitable for such environments where close-up interaction with the digital human is likely. Different example contexts and/or use cases in which interactive system 100 may be used, particularly in the case where digital humans are conveyed as the content, are discussed below.

In one or more embodiments, interactive system 100 may be used to generate or provide a virtual assistant. The virtual assistant may be presented on device 104 within a business or other entity such as a restaurant. Device 104 may present the virtual assistant embodied as a digital human driven by interactive system 100 in lieu of other conventional kiosks found in restaurants and, in particular, fast-food establishments. Interactive system 100 may present a digital human configured to operate as a virtual assistant that is pre-programmed to help with food ordering. The virtual assistant can be configured to answer questions regarding, for example, ingredients, allergy concerns, or other concerns as to the menu offered by the restaurant.

The inventive arrangements described herein also may be used to generate digital humans that may be used as, or function as, virtual news anchors, presenters, greeters, receptionists, coaches, and/or influencers. Example use cases may include, but are not limited to, a digital human performing a daily news-reading, a digital human functioning as a presenter in a promotional or announcement video, a digital human presented in a store or other place of business to interact with users to answer basic questions, a digital human operating as a receptionist in a place of business such as a hotel room, vacation rental, or other attraction/venue. Use cases include those in which accurate mouths and/or lip motion for enhanced realism is preferred, needed, or required. Coaches and influencers would be able to create virtual digital humans of themselves which will help them to scale up and still deliver personalized experiences to end users.

In one or more other examples, digital humans generated in accordance with the inventive arrangements described herein may be included in artificial intelligence (AI) chat bot and/or virtual assistant applications as a visual supplement. Adding a visual component in the form of a digital human to an automated or AI enabled chat bot may provide a degree of humanity to user-computer interactions. The disclosed technology can be used as a visual component and displayed in a display device as may be paired or used with a smart-speaker virtual assistant to make interactions more human-like. The cache-based system described herein maintains the illusion of realism.

In one or more examples the virtual chat assistant may not only message (e.g., send text messages) into a chat with a user, but also have a visual human-like form that reads the answer. In one or more embodiments, based on the disclosed technology, the virtual assistant can be conditioned on both the audio and head position while keeping high quality rendering of the mouth.

In one or more other examples, interactive system 100 may be used in the context of content creation. For example, an online video streamer or other content creator (including, but not limited to, short-form video, ephemeral media, and/or other social media) can use interactive system 100 to automatically create videos instead of recording themselves. The content creator may make various video tutorials, reviews, reports, etc. using digital humans thereby allowing the content creator to create content more efficiently and scale up faster.

The inventive arrangements may be used to provide artificial/digital/virtual humans present across many vertical industries including, but not limited to, hospitality and service industries (e.g., hotel concierge, bank teller), retail industries (e.g., informational agents at physical stores or virtual stores), healthcare industries (e.g., in office or virtual informational assistants), home (e.g., virtual assistants, or implemented into other smart appliances, refrigerators, washers, dryers, and devices), and more. When powered by business intelligence or trained for content specific conversations, artificial/digital/virtual humans become a versatile front-facing solution to improve user experiences.

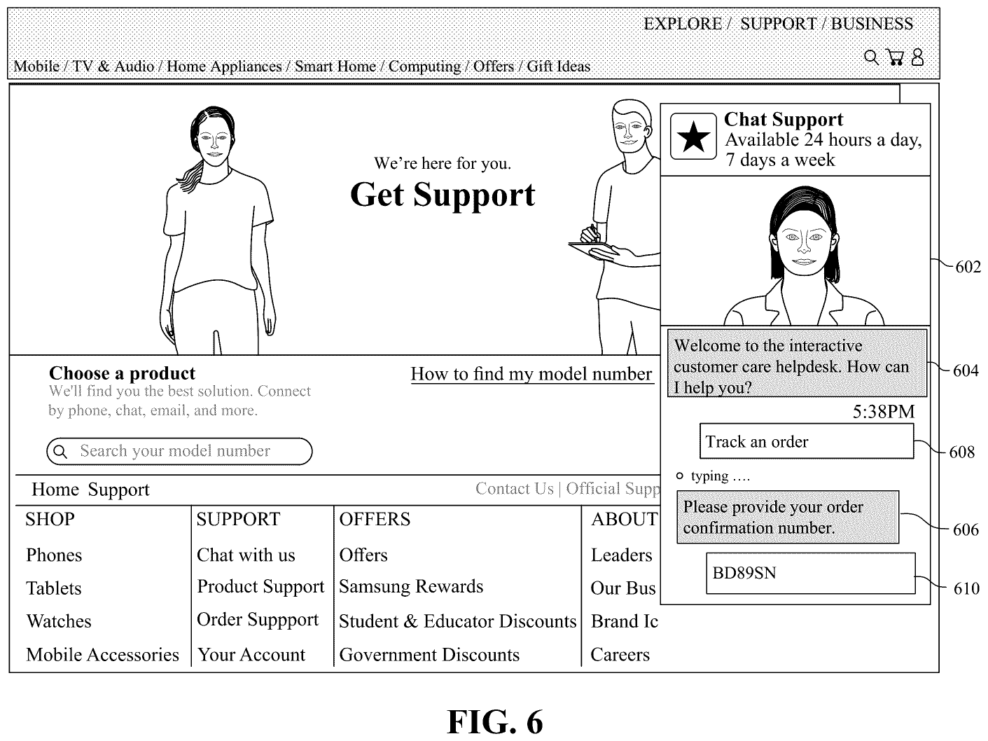

FIG. 6 illustrates interactive system 100 used in the context of chat support in accordance with one or more embodiments of the disclosed technology. In the example, a view generated by device 104 is shown as may be displayed on a display screen of device 104. In the example, region 602 displays content delivered or played by interactive system 100. In the example, the digital human shown speaks the target responses that are also conveyed as text messages 604, 606. The user response is shown as text message 608. Further, the user is able to interact with the digital human as generated by interactive system 100 by way of the field 610 whether by voice or typing.

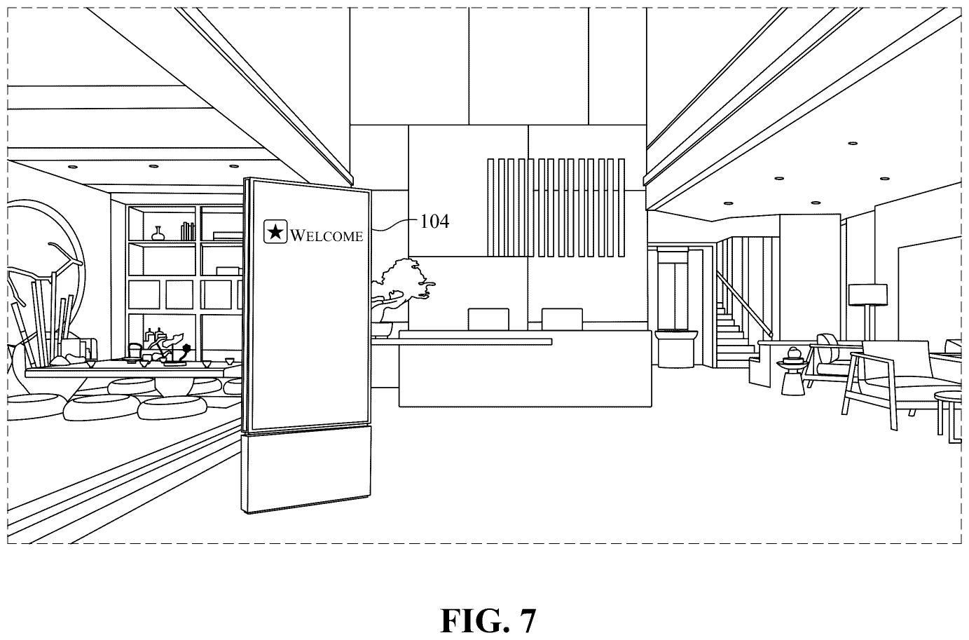

FIG. 7 illustrates an example in which device 104 implements certain features of the interactive system as a kiosk in accordance with one or more embodiments of the disclosed technology. In the example, device 104, being implemented as a kiosk, includes an input transducer (e.g., a microphone), an output transducer (e.g., a speaker), and a display screen to play content to a user and receive input from the user.

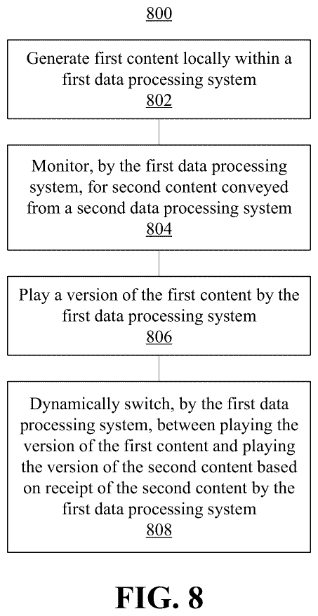

FIG. 8 is an example method 800 illustrating certain operative features of interactive system 100 of FIG. 1 in accordance with the inventive arrangements disclosed herein. In one or more embodiments, method 800 illustrates a method of content delivery.

In block 802, a first data processing system generates first content locally therein. The first data processing system is referred to herein as device 104. The first content may be generated by LN 108. In block 804, the first data processing system monitors for second content conveyed from a second data processing system. The second data processing system is referred to herein as server system 102. The second content may be generated or provided from SSIF 106. In block 806, the first data processing system plays a version of the first content. In block 808, the first data processing system dynamically switches between playing the version of the first content and playing a version of the second content. The switching, as performed by the first data processing system, is based on receipt of the second content. Switch 110 is configured to perform the dynamic switching.

In some aspects, the first content includes a first level of motion and the second content includes a second level of motion that exceeds the first level of motion. The first level of motion may be an amount of motion that is calculated to be less than a threshold amount of motion. The second level of motion may be an amount of motion that is calculated to be greater than or equal to the threshold amount of motion. For example, the first content may include one or more RGB images 204 and the second content may include one or more RGB images 202.

In some aspects, the first content includes media (e.g., video or one or more RGB images) of a non-speaking digital human. For example, the first content may include one or more RGB images 204. The second content includes media (e.g., video or one or more RGB images) of a speaking digital human. For example, the second content may include one or more RGB images 202.

In some aspects, the version of the first content is played continuously. The version of the first content may be played by the first data processing system continuously in absence of the second content and/or until the second content is received.

In some aspects, switch 110 of the first data processing system (e.g., device 104) switches based on the absence of any second content received from the second data processing system. That is, switch 110 passes first content from LN 108 in the absence of second content from server system 102. In some aspects, switch 110 dynamically switches based on the absence of content that includes audio information from the second data processing system. That is, switch 110 passes the first content from LN 108. In response to detecting second content from server system 102 that includes audio information, switch 110 stops passing the first content and passes the second content lieu of the first content. When the second content form the second data processing system stops, switch 110 may resume passing first content provided from LN 108.

In some aspects, the first content and the second content are generated at a first resolution. In that case, the version of the first content is generated by increasing the first resolution of the first content to a second resolution. The second resolution is higher than the first resolution. The version of the second content is generated by increasing the first resolution of the second content to the second resolution. In one or more examples, the version of the first content and the version of the second content are generated by SRN 112. SRN 112 executes locally in device 104.

In some aspects, SRN 112 is implemented as an identity-specific, generative machine learning model. SRN 112 is configured to increase the first resolution of the first content and increase the first resolution of the second content.

In some aspects, the first content includes one or more first RGB images such as RGB image(s) 204 and the second content includes one or more second RGB images such as RGB image(s) 202.

In some aspects, the first content includes one or more first latent space image representations such as latent space image representations 116 and the second content includes one or more second latent space image representations. The second latent space image representations are provided from server system 102.

In some aspects, for the one or more first latent space image representations, the first data processing system generates the version of the first content as one or more RGB images of a digital human that correspond to the one or more first latent space image representations. For example, SRN 112 generates one or more RGB images 506 from one or more latent space image representations 116. For the one or more second latent space image representations, the first data processing system generates the version of the second content as one or more RGB images of the digital human that correspond to the one or more second latent space image representations. For example, SRN 112 generates one or more RGB images 506 from one or more latent space image representations received from server system 102.

FIG. 9 illustrates an example of a data processing system 900 for use with interactive system 100 in accordance with one or more embodiments of the disclosed technology. As defined herein, the term “data processing system” means one or more hardware systems configured to process data, each hardware system including at least one processor and memory, wherein the processor is programmed with computer-readable instructions that, upon execution, initiate operations. Data processing system 900 can include a processor 902, a memory 904, and a bus 906 that couples various system components including memory 904 to processor 902.

Processor 902 may be implemented as one or more processors. In an example, processor 902 is implemented as a central processing unit (CPU). Processor 902 may be implemented as one or more circuits, e.g., hardware, capable of carrying out instructions contained in program code. The circuit may be an integrated circuit or embedded in an integrated circuit. Processor 902 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, Graphics Processing Unit (GPU), Digital Signal Processor (DSP), and the like.

Bus 906 represents one or more of any of a variety of communication bus structures. By way of example, and not limitation, bus 906 may be implemented as a Peripheral Component Interconnect Express (PCIe) bus. Data processing system 900 typically includes a variety of computer system readable media. Such media may include computer-readable volatile and non-volatile media and computer-readable removable and non-removable media.

Memory 904 can include computer-readable media in the form of volatile memory, such as random-access memory (RAM) 908 and/or cache memory 910. Data processing system 900 also can include other removable/non-removable, volatile/non-volatile computer storage media. By way of example, storage system 912 can be provided for reading from and writing to a non-removable, non-volatile magnetic and/or solid-state media (not shown and typically called a “hard drive”), which may be included in storage system 912. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 906 by one or more data media interfaces. Memory 904 is an example of at least one computer program product.

Memory 904 is capable of storing computer-readable program instructions that are executable by processor 902. For example, the computer-readable program instructions can include an operating system, one or more application programs, other program code, and program data. In one or more embodiments, memory 904 may store an executable framework implementing SSIF 106 as described herein such that processor 902 may execute the framework.

Processor 902, in executing the computer-readable program instructions, is capable of performing the various operations described herein that are attributable to a computer. It should be appreciated that data items used, generated, and/or operated upon by data processing system 900 are functional data structures that impart functionality when employed by data processing system 900. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 900 may include one or more Input/Output (I/O) interfaces 918 communicatively linked to bus 906. I/O interface(s) 918 allow data processing system 900 to communicate with one or more external devices and/or communicate over one or more networks such as a local area network (LAN), a wide area network (WAN), and/or a public network (e.g., the Internet). Examples of I/O interfaces 918 may include, but are not limited to, network cards, modems, network adapters, hardware controllers, etc. Examples of external devices also may include devices that allow a user to interact with data processing system 900 (e.g., a display, a keyboard, and/or a pointing device) and/or other devices.

Data processing system 900 is only one example implementation. Data processing system 900 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

As used herein, the term “cloud computing” refers to a computing model that facilitates convenient, on-demand network access to a shared pool of configurable computing resources such as networks, servers, storage, applications, ICs (e.g., programmable ICs), GPUs, and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 9 is not intended to suggest any limitation as to the scope of use or functionality of example implementations described herein. Data processing system 900 is an example of computer hardware that is capable of performing the various operations described within this disclosure. In this regard, data processing system 900 may include fewer components than shown or additional components not illustrated in FIG. 9 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

In one or more other embodiments, data processing system 900 or another one similar thereto may be used to implement device 104. In using data processing system 900 as device 104, other devices may be included in data processing system 900 and connected through I/O interfaces 918. Such additional devices, components, and/or systems may include one or more wireless radios and/or transceivers, a display screen, an audio system having one or more input transducers (e.g., microphones) and one or more output transducers (e.g., speakers), one or more cameras, a keyboard, a mouse, and/or any of a variety of available peripherals. The display screen may be implemented as a touchscreen.

FIG. 10 illustrates an example implementation of device 104 for use with interactive system 100 in accordance with one or more embodiments of the disclosed technology. Device 104 includes at least one processor 1005. Processor 1005 is coupled to memory 1010 through interface circuitry 1015. Device 104 stores computer readable instructions (also referred to as “program code”) within memory 1010. Memory 1010 is an example of computer readable storage media. Processor 1005 executes the program code accessed from memory 1010 via interface circuitry 1015.

Memory 1010 includes one or more physical memory devices such as, for example, a local memory 1020 and a bulk storage device 1025. Local memory 1020 is implemented as non-persistent memory device(s) generally used during actual execution of the program code. Examples of local memory 1020 include random access memory (RAM) and/or any of the various types of RAM that are suitable for use by a processor during execution of program code. Bulk storage device 1025 is implemented as a persistent data storage device. Examples of bulk storage device 1025 include a hard disk drive (HDD), a solid-state drive (SSD), flash memory, a read-only memory (ROM), an erasable programmable read-only memory (EPROM), electrically erasable programmable read-only memory (EEPROM), or other suitable memory. Device 104 may also include one or more cache memories (not shown) that provide temporary storage of at least some program code in order to reduce the number of times program code must be retrieved from a bulk storage device during execution.

Examples of interface circuitry 1015 include, but are not limited to, an input/output (I/O) subsystem, an I/O interface, a bus system, and a memory interface. For example, interface circuitry 1015 may be implemented as any of a variety of bus structures and/or combinations of bus structures including a memory bus or memory controller, a peripheral bus, an accelerated graphics port, and a processor or local bus.

In one or more embodiments, processor 1005, memory 1010, and/or interface circuitry 1015 are implemented as separate components. In one or more embodiments, processor 1005, memory 1010, and/or interface circuitry 1015 are integrated in one or more integrated circuits. The various components in device 104, for example, can be coupled by one or more communication buses or signal lines (e.g., interconnects and/or wires). In particular embodiments, memory 1010 is coupled to interface circuitry 1015 via a memory interface, e.g., a memory controller (not shown).

Device 104 may include one or more display screens 1030. In particular embodiments, display screen 1030 is implemented as touch-sensitive or touchscreen display capable of receiving touch input from a user. A touch sensitive display and/or a touch-sensitive pad is capable of detecting contact, movement, gestures, and breaks in contact using any of a variety of available touch sensitivity technologies. Example touch sensitive technologies include, but are not limited to, capacitive, resistive, infrared, and surface acoustic wave technologies, and other proximity sensor arrays or other elements for determining one or more points of contact with a touch sensitive display and/or device.

Device 104 may include a camera subsystem 1040. Camera subsystem 1040 can be coupled to interface circuitry 1015 directly or through a suitable input/output (I/O) controller. Camera subsystem 1040 can be coupled to an optical sensor 1042. Optical sensor 1042 may be implemented using any of a variety of technologies. Examples of optical sensor 1042 can include, but are not limited to, a charged coupled device (CCD) or a complementary metal-oxide semiconductor (CMOS) optical sensor. Camera subsystem 1040 and optical sensor 1042 are capable of performing camera functions such as recording images and/or recording video.

Device 104 may include an audio subsystem 1045. Audio subsystem 1045 can be coupled to interface circuitry 1015 directly or through a suitable input/output (I/O) controller. Audio subsystem 1045 can be coupled to a speaker 1046 and a microphone 1048 to facilitate voice-enabled functions, such as voice recognition, voice replication, digital recording, and telephony functions.

Device 104 may include one or more wireless communication subsystems 1050. Each of wireless communication subsystem(s) 1050 can be coupled to interface circuitry 1015 directly or through a suitable I/O controller (not shown). Each of wireless communication subsystem(s) 1050 is capable of facilitating communication functions. Examples of wireless communication subsystems 1050 can include, but are not limited to, radio frequency receivers and transmitters, and optical (e.g., infrared) receivers and transmitters. The specific design and implementation of wireless communication subsystem 1050 can depend on the particular type of device 104 implemented and/or the communication network(s) over which device 104 is intended to operate.

As an illustrative and non-limiting example, wireless communication subsystem(s) 1050 may be designed to operate over one or more mobile networks (e.g., GSM, GPRS, EDGE), a WiFi network which may include a WiMax network, a short-range wireless network (e.g., a Bluetooth network), and/or any combination of the foregoing. Wireless communication subsystem(s) 1050 can implement hosting protocols such that device 104 can be configured as a base station for other wireless devices.

Device 104 may include one or more sensors 1055. Each of sensors 1055 can be coupled to interface circuitry 1015 directly or through a suitable I/O controller (not shown). Examples of sensors 1055 that can be included in device 104 include, but are not limited to, a motion sensor, a light sensor, and a proximity sensor to facilitate orientation, lighting, and proximity functions, respectively, of device 104. Other examples of sensors 1055 can include, but are not limited to, a location sensor (e.g., a GPS receiver and/or processor) capable of providing geo-positioning sensor data, an electronic magnetometer (e.g., an integrated circuit chip) capable of providing sensor data that can be used to determine the direction of magnetic North for purposes of directional navigation, an accelerometer capable of providing data indicating change of speed and direction of movement of device 104 in 3-dimensions, and an altimeter (e.g., an integrated circuit) capable of providing data indicating altitude.

Device 104 further may include one or more input/output (I/O) devices 1060 coupled to interface circuitry 1015. I/O devices 1060 may be coupled to device 104, e.g., interface circuitry 1015, either directly or through intervening I/O controllers (not shown). Examples of I/O devices 1060 include, but are not limited to, a track pad, a keyboard, a display device, a pointing device, one or more communication ports (e.g., Universal Serial Bus (USB) ports), a network adapter, and buttons or other physical controls. A network adapter refers to circuitry that enables device 104 to become coupled to other systems, computer systems, remote printers, and/or remote storage devices through intervening private or public networks. Modems, cable modems, Ethernet interfaces, and wireless transceivers not part of wireless communication subsystem(s) 1050 are examples of different types of network adapters that may be used with device 104. One or more of I/O devices 1060 may be adapted to control functions of one or more or all of sensors 1055 and/or one or more of wireless communication subsystem(s) 1050.

Memory 1010 stores program code. Examples of program code include, but are not limited to, routines, programs, objects, components, logic, and other data structures. For purposes of illustration, memory 1010 stores an operating system 1070 and application(s) 1075. Applications 1075 may include LN 108, switch 110, and/or SRN 112. Operating system 1070 and/or applications 1075, when executed, are capable of causing device 104 and/or other devices that may be communicatively linked with device 104 to perform the various operations described herein. Memory 1010 is also capable of storing data, whether data utilized by operating system 1070, data utilized by application(s) 1075, data received from user inputs, data generated by one or more or all of sensor(s) 1055, data received and/or generated by camera subsystem 1040, data received and/or generated by audio subsystem 1045, and/or data received by I/O devices 1060.

In an aspect, operating system 1070 and application(s) 1075, being implemented in the form of executable program code, are executed by device 104 and, more particularly, by processor 1005, to perform the operations described within this disclosure. As such, operating system 1070 and application(s) 1075 may be considered an integrated part of device 104. Further, it should be appreciated that any data and/or program code used, generated, and/or operated upon by device 104 (e.g., processor 1005) are functional data structures that impart functionality when employed as part of device 104.

Memory 1010 is capable of storing other program code. Examples of other program code include, but are not limited to, instructions that facilitate communicating with one or more additional devices, one or more computers and/or one or more servers; graphic user interface (GUI) and/or UI processing; sensor-related processing and functions; phone-related processes and functions; electronic-messaging related processes and functions; Web browsing-related processes and functions; media processing-related processes and functions; GPS and navigation-related processes and functions; security functions; and camera-related processes and functions including Web camera and/or Web video functions.

Device 104 further can include a power source (not shown). The power source is capable of providing electrical power to the various elements of device 104. In an embodiment, the power source is implemented as one or more batteries. The batteries may be implemented using any of a variety of known battery technologies whether disposable (e.g., replaceable) or rechargeable. In another embodiment, the power source is configured to obtain electrical power from an external source and provide power (e.g., DC power) to the elements of device. In the case of a rechargeable battery, the power source further may include circuitry that is capable of charging the battery or batteries when coupled to an external power source.

Device 104 is provided for purposes of illustration and not limitation. A device and/or system configured to perform the operations described herein may have a different architecture than illustrated in FIG. 10. The architecture may be a simplified version of the architecture described in connection with FIG. 10 that includes a memory capable of storing instructions and a processor capable of executing instructions. In this regard, device 104 may include fewer components than shown or additional components not illustrated in FIG. 10 depending upon the particular type of device that is implemented. In addition, the particular operating system and/or application(s) included may vary according to device type as may the types of I/O devices included. Further, one or more of the illustrative components may be incorporated into, or otherwise form a portion of, another component. For example, a processor may include at least some memory.

Device 104 may be implemented as a data processing system, which may include any of a variety of communication devices or other systems suitable for storing and/or executing program code. Example implementations of device 104 may include, but are not to limited to, a smart phone or other mobile device or phone, a wearable computing device, a computer (e.g., desktop, laptop, or tablet computer), a television or other appliance with a display, a computer system included and/or embedded in another larger system such as an automobile, a virtual reality (VR) system, an augmented reality (AR) system, a mixed reality (MR) system, an extended reality system (XR), or a metaverse system.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “output” means storing in physical memory elements, e.g., devices, writing to a display or other peripheral output device, sending or transmitting to another system, exporting, or the like.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the disclosed technology. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method of content distribution, comprising:
generating first content locally within a first data processing system;
monitoring, by the first data processing system, for second content conveyed from a second data processing system;
playing a version of the first content by the first data processing system; and
dynamically switching, by the first data processing system, between playing the version of the first content and playing a version of the second content based on receipt of the second content by the first data processing system.

2. The computer-implemented method of claim 1, wherein the first content includes a first level of motion and the second content includes a second level of motion that exceeds the first level of motion.

3. The computer-implemented method of claim 1, wherein the first content includes media of a non-speaking digital human, and wherein the second content includes media of a speaking digital human.

4. The computer-implemented method of claim 1, wherein the version of the first content is played continuously in absence of the second content and until the second content is received.

5. The computer-implemented method of claim 1, wherein the first content and the second content are generated at a first resolution, the method further comprising:
generating the version of the first content by increasing the first resolution of the first content to a second resolution, wherein the second resolution is higher than the first resolution; and
generating the version of the second content by increasing the first resolution of the second content to the second resolution.

6. The computer-implemented method of claim 5, wherein an identity-specific, generative machine learning model increases the first resolution of the first content and increases the first resolution of the second content.

7. The computer-implemented method of claim 5, wherein the first content includes one or more first red, green, blue (RGB) images and the second content includes one or more second RGB images.

8. The computer-implemented method of claim 1, wherein the first content includes one or more first latent space image representations and the second content includes one or more second latent space image representations.

9. The computer-implemented method of claim 8, further comprising:
for the one or more first latent space image representations, generating the version of the first content as one or more red, green, blue (RGB) images of a digital human that correspond to the one or more first latent space image representations; and
for the one or more second latent space image representations, generating the version of the second content as one or more RGB images of the digital human that correspond to the one or more second latent space image representations.

10. A data processing system, comprising:
a processor configured to executing operations including:
generating first content locally within the data processing system;
monitoring, by the data processing system, for second content conveyed from a remote system;
playing a version of the first content by the data processing system; and
dynamically switching, by the data processing system, between playing the version of the first content and playing a version of the second content based on receipt of the second content by the data processing system.

11. The data processing system of claim 10, wherein the first content includes a first level of motion and the second content includes a second level of motion that exceeds the first level of motion.

12. The data processing system of claim 10, wherein the first content includes media of a non-speaking digital human, and wherein the second content includes media of a speaking digital human.

13. The data processing system of claim 10, wherein the version of the first content is played content continuously in absence of the second content and until the second content is received.

14. The data processing system of claim 10, wherein the first content and the second content are generated at a first resolution, and wherein the processor is configured to execute operations comprising:
generating the version of the first content by increasing the first resolution of the first content to a second resolution, wherein the second resolution is higher than the first resolution; and
generating the version of the second content by increasing the first resolution of the second content to the second resolution.

15. The data processing system of claim 14, wherein an identity-specific, generative machine learning model increases the first resolution of the first content and increases the first resolution of the second content.

16. The data processing system of claim 14, wherein the first content includes one or more first red, green, blue (RGB) images and the second content includes one or more second RGB images.

17. The data processing system of claim 14, wherein the first content includes one or more first latent space image representations and the second content includes one or more second latent space image representations.

18. The data processing system of claim 17, wherein the processor is configured to execute operations comprising:
for the one or more first latent space image representations, generating the version of the first content as one or more red, green, blue (RGB) images of a digital human that correspond to the one or more first latent space image representations; and
for the one or more second latent space image representations, generating the version of the second content as one or more RGB images of the digital human that correspond to the one or more second latent space image representations.

19. A computer program product, comprising:
one or more computer readable storage media, and program instructions collectively stored on the one or more computer readable storage media, wherein the program instructions are executable by a data processing system to perform operations including:
generating first content locally within the data processing system;
monitoring, by the data processing system, for second content conveyed from a remote system;
playing a version of the first content by the data processing system; and
dynamically switching, by the data processing system, between playing the version of the first content and playing a version of the second content based on receipt of the second content by the data processing system.

20. The computer program product of claim 19, wherein the first content and the second content are generated at a first resolution, wherein the program instructions are executable by the data processing system to perform operations comprising:
generating the version of the first content by increasing the first resolution of the first content to a second resolution, wherein the second resolution is higher than the first resolution; and
generating the version of the second content by increasing the first resolution of the second content to the second resolution.
